(19) United States
(12) Patent Application Publication
(10) Pub. No.: US 2019/0234239 A1
(43) Pub. Date: Aug. 1, 2019

(54) GAS TURBINE ENGINE

(71) Applicant: HONDA MOTOR CO., LTD., Tokyo (JP)

(72) Inventor: Tsubasa Tsujimoto, Wako-shi (JP)

(21) Appl. No.: 16/262,376

(22) Filed: Jan. 30, 2019

(30) Foreign Application Priority Data
Feb. 1, 2018 (JP) 2018-16784

(51) Int. Cl. F01D 25/16; F02K 3/062; F16C 19/10; F16C 19/54

(52) U.S. Cl. CPC F01D 25/168; F02K 3/062; F05D 2240/50; F16C 19/54; F05D 2240/52; F16C 19/10

(57) ABSTRACT

In a gas turbine engine, a third bearing having a squeeze film damper is disposed between an outer periphery of an intermediate part in an axial direction of a low pressure system shaft and an inner periphery of an intermediate part in an axial direction a high pressure system shaft. Not only is it possible, by connecting the respective intermediate parts in the axial direction of the low and high pressure system shafts to each other via the third bearing to thus enhance bending stiffness of the low and high pressure system shafts and suppress centrifugal whirling, to prevent vibration from occurring, but it is also possible to suppress transmission of vibration between the low and high pressure system shafts by the squeeze film damper of the third bearing, thereby minimizing transmission of vibration to a casing.

### CROSS REFERENCE TO RELATED APPLICATIONS

The present application claims priority under 35 U.S.C. § 119 to Japanese Patent Application No. 2018-16784 filed Feb. 1, 2018 the entire contents of which are hereby incorporated by reference.

### BACKGROUND OF THE INVENTION

### Field of the Invention

The present invention relates to a gas turbine engine comprising a low pressure system shaft that supports a low pressure compressor and a low pressure turbine, a high pressure system shaft that is fitted around an outer periphery of an intermediate part in an axial direction of the low pressure system shaft and supports a high pressure compressor and a high pressure turbine, a front first bearing and a rear first bearing that support opposite ends in the axial direction of the low pressure system shaft on a casing, and a front second bearing and a rear second bearing that support opposite ends in an axial direction of the high pressure system shaft on the casing.

### Description of the Related Art

Published Japanese Translation No. 2015-520829 of PCT/US2013/037509 has made known a twin shaft type gas turbine engine in which a high pressure system shaft supporting a high pressure compressor and a high pressure turbine is coaxially fitted around the outer periphery of a low pressure system shaft supporting a low pressure compressor and a low pressure turbine.

In such a twin shaft type gas turbine engine, either of the low pressure system shaft and the high pressure system shaft is a long shaft; the low pressure system shaft is supported on a casing by means of a bearing at only two positions at opposite ends in the axial direction and the high pressure system shaft is supported on the casing by means of a bearing at only two positions at opposite ends in the axial direction, and there is therefore a possibility that when a weight imbalance occurs in a rotating portion, the low pressure system shaft or the high pressure system shaft will undergo centrifugal whirling, vibration will occur, and the casing, to which the vibration is transmitted, will be damaged.

### SUMMARY OF THE INVENTION

The present invention has been accomplished in light of the above circumstances, and it is an object thereof to reliably prevent, by a simple structure, a low pressure system shaft and a high pressure system shaft of a twin shaft type gas turbine engine from undergoing centrifugal whirling.

In order to achieve the object, according to a first aspect of the present invention, there is provided a gas turbine engine comprising a low pressure system shaft that supports a low pressure compressor and a low pressure turbine, a high pressure system shaft that is fitted around an outer periphery of an intermediate part in an axial direction of the low pressure system shaft and supports a high pressure compressor and a high pressure turbine, a front first bearing and a rear first bearing that support opposite ends in the axial direction of the low pressure system shaft on a casing, and a front second bearing and a rear second bearing that support opposite ends in an axial direction of the high pressure system shaft on the casing, wherein a third bearing having a squeeze film damper is disposed between the outer periphery of the intermediate part in the axial direction of the low pressure system shaft and an inner periphery of an intermediate part in the axial direction the high pressure system shaft.

In accordance with the first aspect, the gas turbine engine includes the low pressure system shaft supporting the low pressure compressor and the low pressure turbine, the high pressure system shaft fitted around the outer periphery of the intermediate part in the axial direction of the low pressure system shaft and supporting the high pressure compressor and the high pressure turbine, the front first bearing and the rear first bearing supporting the opposite ends in the axial direction of the low pressure system shaft on the casing, and the front second bearing and the rear second bearing supporting the opposite ends in the axial direction of the high pressure system shaft on the casing. Since the third bearing having the squeeze film damper is disposed between the outer periphery of the intermediate part in the axial direction of the low pressure system shaft and the inner periphery of the intermediate part in the axial direction the high pressure system shaft, not only is it possible, by connecting the intermediate part in the axial direction of the low pressure system shaft and the intermediate part in the axial direction of the high pressure system shaft to each other via the third bearing to thus enhance the bending stiffness of the low pressure system shaft and the high pressure system shaft and suppress centrifugal whirling, to prevent vibration from occurring, but it is also possible to suppress the transmission of vibration between the low pressure system shaft and the high pressure system shaft by means of the squeeze film damper of the third bearing, thereby minimizing the transmission of vibration to the casing.

According to a second aspect of the present invention, in addition to the first aspect, the high pressure system shaft is formed from a front high pressure system shaft and a rear high pressure system shaft divided between the front second bearing and the rear second bearing, the third bearing is supported on an inner periphery of one of the front high pressure system shaft and the rear high pressure system shaft, and the front high pressure system shaft and the rear high pressure system shaft are joined by a coupling.

In accordance with the second aspect, since the high pressure system shaft is formed from the front high pressure system shaft and the rear high pressure system shaft divided between the front second bearing and the rear second bearing, the third bearing is supported on the inner periphery of one of the front high pressure system shaft and the rear high pressure system shaft, and the front high pressure system shaft and the rear high pressure system shaft are joined by the coupling, it is possible to easily assemble the third bearing in a space sandwiched between the outer periphery of the low pressure system shaft and the inner periphery of the high pressure system shaft.

Note that an inner casing 12 of embodiments corresponds to the casing of the present invention, an intermediate bearing 37 of the embodiments corresponds to the third bearing of the present invention, and joining flanges 16b and a spline 42 of the embodiments correspond to the coupling of the present invention.

The above and other objects, characteristics and advantages of the present invention will be clear from detailed descriptions of the preferred embodiments which will be provided below while referring to the attached drawings.

### BRIEF DESCRIPTION OF THE DRAWINGS

FIG. 1 is a diagram showing the overall structure of a gas turbine engine (first embodiment).

FIG. 2 is an enlarged view of part 2 in FIG. 1 (first embodiment).

FIGS. 3A to 3D are diagrams for explaining the operation when assembling the gas turbine engine (first embodiment).

FIG. 4 is a view corresponding to FIG. 2 (second embodiment).

FIGS. 5A to 5D are diagrams for explaining the operation when assembling a gas turbine engine (second embodiment).

### DESCRIPTION OF THE PREFERRED EMBODIMENTS

### First Embodiment

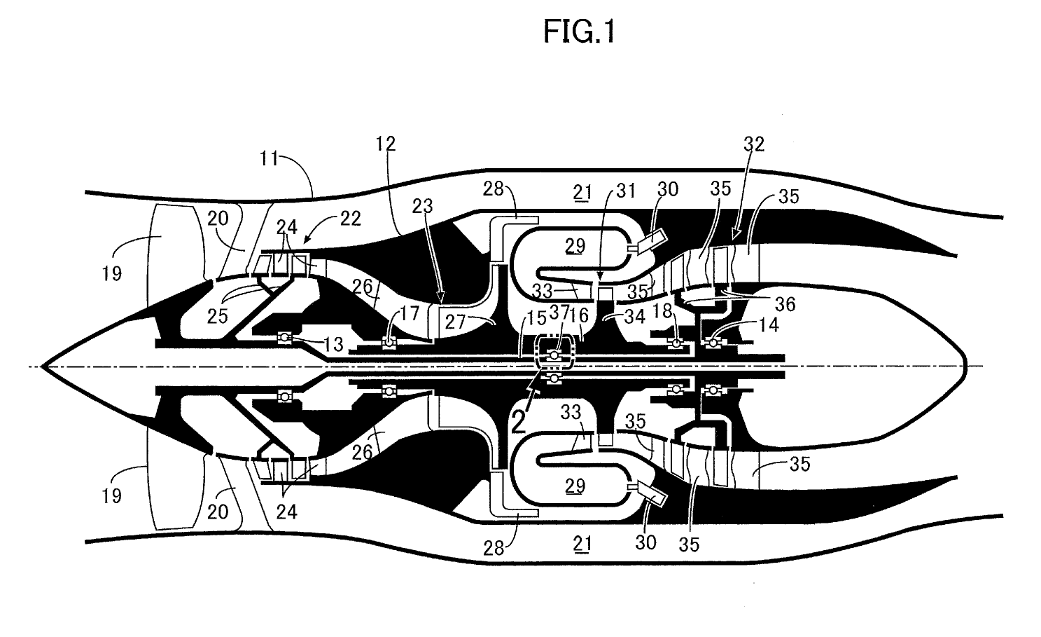

A first embodiment of the present invention is explained below by reference to FIG. 1 to FIG. 3.

As shown in FIG. 1, a gas turbine engine for an airplane to which the present invention is applied includes an outer casing 11 and an inner casing 12, and a front part and a rear part of a low pressure system shaft 15 are rotatably supported in the interior of the inner casing 12 via a front first bearing 13 and a rear first bearing 14. A tubular high pressure system shaft 16 is relatively rotatably fitted around the outer periphery of an intermediate part in the axial direction of the low pressure system shaft 15, a front part of the high pressure system shaft 16 is rotatably supported on the inner casing 12 via a front second bearing 17, and a rear part of the high pressure system shaft 16 is relatively rotatably supported on the low pressure system shaft 15 via a rear second bearing 18. An intermediate bearing 37 is provided between the outer periphery of the low pressure system shaft 15 and the inner periphery of the high pressure system shaft 16 at a position sandwiched by the front second bearing 17 and the rear second bearing 18.

Fixed to the front end of the low pressure system shaft 15 is a front fan 19 having its blade tip facing an inner face of the outer casing 11, and part of the air sucked in by the front fan 19 passes through a stator vane 20 disposed between the outer casing 11 and the inner casing 12; part thereof then passes through an annular bypass duct 21 formed between the outer casing 11 and the inner casing 12 and is jetted rearward, and another part is supplied to an axial low pressure compressor 22 and a centrifugal high pressure compressor 23 disposed in the interior of the inner casing 12.

The low pressure compressor 22 includes a stator vane 24 fixed to the interior of the inner casing 12 and a low pressure compressor wheel 25 equipped with a compressor blade on the outer periphery and fixed to the low pressure system shaft 15. The high pressure compressor 23 includes a stator vane 26 fixed to the interior of the inner casing 12 and a high pressure compressor wheel 27 equipped with a compressor blade on the outer periphery and fixed to the high pressure system shaft 16.

A reverse flow combustion chamber 29 is disposed to the rear of a diffuser 28 connected to the outer periphery of the high pressure compressor wheel 27, and fuel is injected into the interior of the reverse flow combustion chamber 29 from a fuel injection nozzle 30. Fuel and air are mixed and combusted in the interior of the reverse flow combustion chamber 29, and the combustion gas thus generated is supplied to a high pressure turbine 31 and a low pressure turbine 32.

The high pressure turbine 31 includes a nozzle guide vane 33 fixed to the interior of the inner casing 12, and a high pressure turbine wheel 34 equipped with a turbine blade on the outer periphery and fixed to the high pressure system shaft 16. The low pressure turbine 32 includes a nozzle guide vane 35 fixed to the interior of the inner casing 12, and a low pressure turbine wheel 36 equipped with a turbine blade on the outer periphery and fixed to the low pressure system shaft 15.

Therefore, when the high pressure system shaft 16 is driven by a starter motor, which is not illustrated, air sucked in by the high pressure compressor wheel 27 is supplied to the reverse flow combustion chamber 29, mixed with fuel, and combusted, and the combustion gas thus generated drives the high pressure turbine wheel 34 and the low pressure turbine wheel 36. As a result, the low pressure system shaft 15 and the high pressure system shaft 16 rotate, and the front fan 19, the low pressure compressor wheel 25, and the high pressure compressor wheel 27 compress air and supply it to the reverse flow combustion chamber 29, the operation of the gas turbine engine thus continuing even when the starter motor is stopped.

While the gas turbine engine is operating, part of the air sucked in by the front fan 19 passes through the bypass duct 21 and is jetted rearward, thus generating the main thrust at a time of low speed flying in particular. The rest of the air sucked in by the front fan 19 is supplied to the reverse flow combustion chamber 29, mixed with fuel, combusted to thus drive the low pressure system shaft 15 and the high pressure system shaft 16, and then jetted rearward to generate thrust.

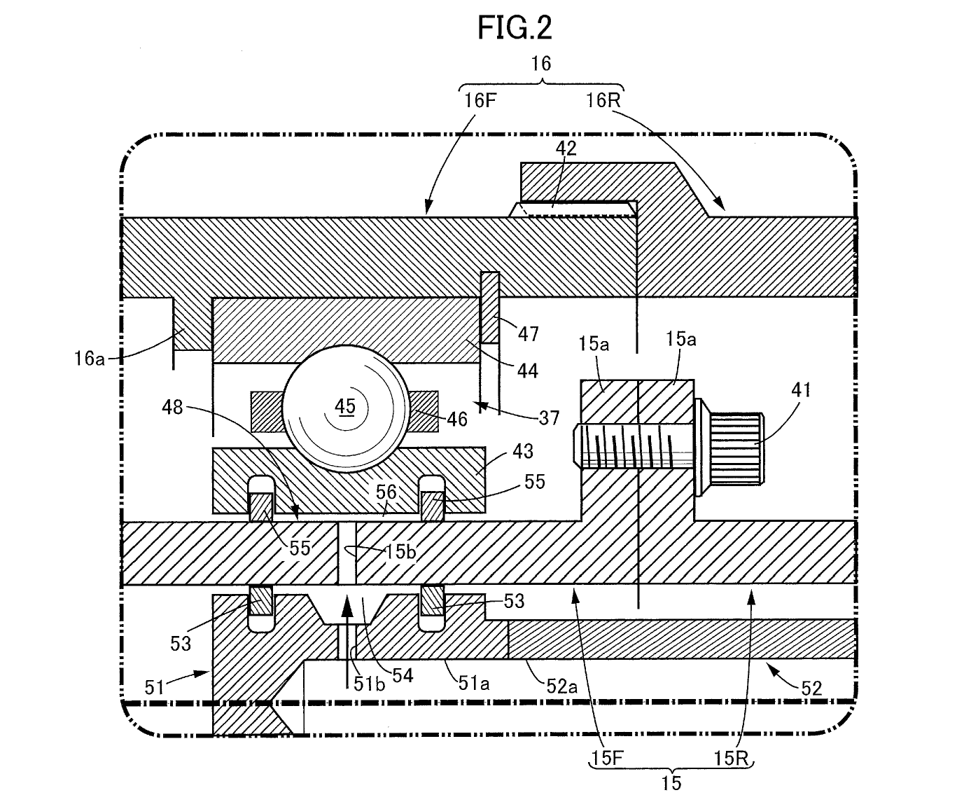

The structure of the periphery of the intermediate bearing 37 is now explained by reference to FIG. 2.

The low pressure system shaft 15 is divided into two, that is, a front low pressure system shaft 15F on the front side and a rear low pressure system shaft 15R on the rear side, the front low pressure system shaft 15F and the rear low pressure system shaft 15R being joined as a unit by fastening, with a plurality of bolts 41, a joining flange 15a protruding radially outward from the rear end of the front low pressure system shaft 15F and a joining flange 15a protruding radially outward from the front end of the rear low pressure system shaft 15R.

The high pressure system shaft 16 is divided into two, that is, a front high pressure system shaft 16F on the front side and a rear high pressure system shaft 16R on the rear side, the front high pressure system shaft 16F and the rear high pressure system shaft 16R being joined as a unit by linking, with a spline 42, the outer periphery of the rear end of the front high pressure system shaft 16F and the inner periphery of the front end of the rear high pressure system shaft 16R.

The intermediate bearing 37 includes an inner race 43, an outer race 44, a plurality of balls 45 disposed between the inner race 43 and the outer race 44, and a retainer 46 retaining the balls 45 at equal intervals in the peripheral direction. The outer race 44 of the intermediate bearing 37 is fitted into the inner periphery of the front high pressure system shaft 16F and latched by a step portion 16a and a clip 47 so that it cannot move in the axial direction.

A squeeze film damper 48 accompanying the intermediate bearing 37 includes an annular stationary member 51 disposed on the radially inner side of the front low pressure system shaft 15F, and fixing, to a stationary part such as the inner casing 12 or the like, a linking member 52 extending rearward from the stationary member 51 and extending to the outside from the rear end of the low pressure system shaft 15 non-movably fixes the stationary member 51 to the interior of the front low pressure system shaft 15F. Abutting a pair of seal rings 53 provided on the outer periphery of the stationary member 51 against the inner periphery of the front low pressure system shaft 15F defines an annular oil chamber 54 between the outer periphery of the stationary member 51 and the inner periphery of the front low pressure system shaft 15F. Oil is supplied from an oil pump, which is not illustrated, to the oil chamber 54 through oil passages 52a and 51a formed in the interior of the linking member 52 and the stationary member 51 and an oil hole 51b extending through the stationary member 51 in the radial direction.

Furthermore, the squeeze film damper 48 includes an annular oil chamber 56 sandwiched between the inner periphery of the inner race 43 of the intermediate bearing 37 and the outer periphery of the front low pressure system shaft 15F and defined by a pair of seal rings 55 provided on the inner periphery of the inner race 43 of the intermediate bearing 37. Oil of the oil chamber 54 is supplied to this oil chamber 56 via an oil hole 15b extending through the front low pressure system shaft 15F.

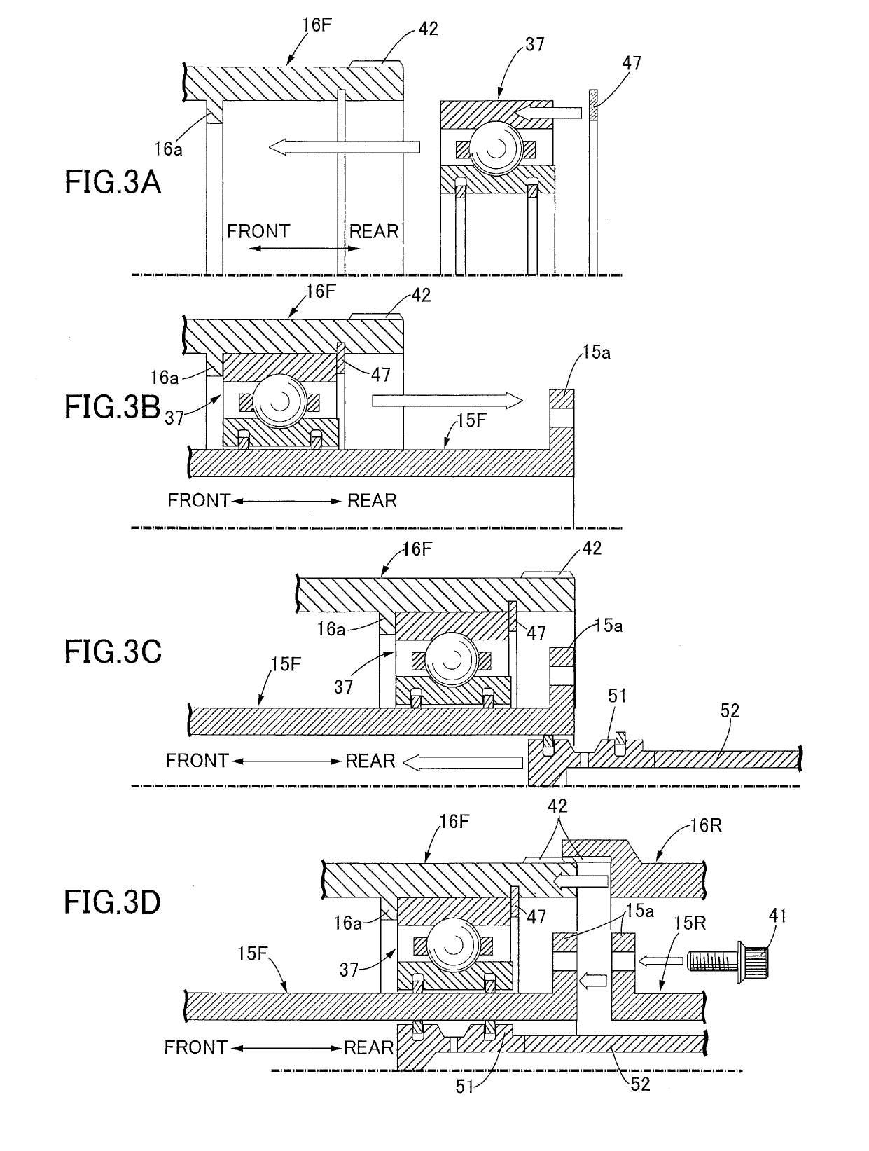

Since the intermediate bearing 37 is disposed in a confined space between the low pressure system shaft 15 and the high pressure system shaft 16, ingenuity is needed for the assembly thereof. The procedure for assembly of the intermediate bearing 37 is explained below by reference to FIGS. 3A to 3D.

First, the intermediate bearing 37 is inserted into the inner periphery of the front high pressure system shaft 16F from the rear toward the front, and the outer race 44 is abutted against the step portion 16a of the front high pressure system shaft 16F and latched by means of the clip 47, thus supporting the intermediate bearing 37 on the front high pressure system shaft 16F (see FIG. 3A).

Subsequently, the front high pressure system shaft 16F integrally having the intermediate bearing 37 is inserted from the front to the rear so as to fit around the outer periphery of the front low pressure system shaft 15F (see FIG. 3B). Subsequently, the stationary member 51 and the linking member 52, which are joined as a unit in advance, are inserted from the rear to the front into the interior of the front low pressure system shaft 15F (see FIG. 3C). Subsequently, the front end of the rear low pressure system shaft 15R is fastened to the rear end of the front low pressure system shaft 15F by means of the bolts 41, and the front end of the rear high pressure system shaft 16R is fastened to the rear end of the front high pressure system shaft 16F by means of the spline 42 (see FIG. 3D). Lastly, the linking member 52 projecting from the rear end of the rear low pressure system shaft 15R is fixed to an appropriate fixing part of the inner casing 12.

In this way, not only is it possible to assemble the intermediate bearing 37 in a confined space between the low pressure system shaft 15 and the high pressure system shaft 16 without any problem, but it is also possible to easily assemble the stationary member 51 in a deep position of the low pressure system shaft 15.

As described above, in accordance with the present embodiment, disposing the intermediate bearing 37 between the outer periphery of the low pressure system shaft 15 and the inner periphery of the high pressure system shaft 16 not only enhances the stiffness of the low pressure system shaft 15 to thus suppress the occurrence of vibration due to centrifugal whirling, but also damps, by means of the squeeze film damper 48, vibration due to centrifugal whirling occurring on the low pressure system shaft 15 and the high pressure system shaft 16 that has not been sufficiently suppressed, thereby reliably preventing any damage to the inner casing 12 caused by the transmission of vibration.

That is, when the low pressure system shaft 15 and the high pressure system shaft 16 undergo vibration, the size of the gap in the radial direction of the oil chamber 56 of the squeeze film damper 48 increases or decreases, and a damping function is exhibited by a resistance force generated by flow and compression of viscous oil of the squeeze film within the oil chamber 56, thus preventing the transmission of vibration from the low pressure system shaft 15 to the high pressure system shaft 16 and the transmission of vibration from the high pressure system shaft 16 to the low pressure system shaft 15.

When the squeeze film damper 48 exhibits a damping effect, oil that has absorbed vibrational energy generates heat and its temperature rises, the oil having risen in temperature is discharged in succession from the abutment clearance of the seal rings 55 of the squeeze film damper 48, and fresh oil is supplied from the oil pump, thus maintaining the damping function of the squeeze film damper 48.

### Second Embodiment

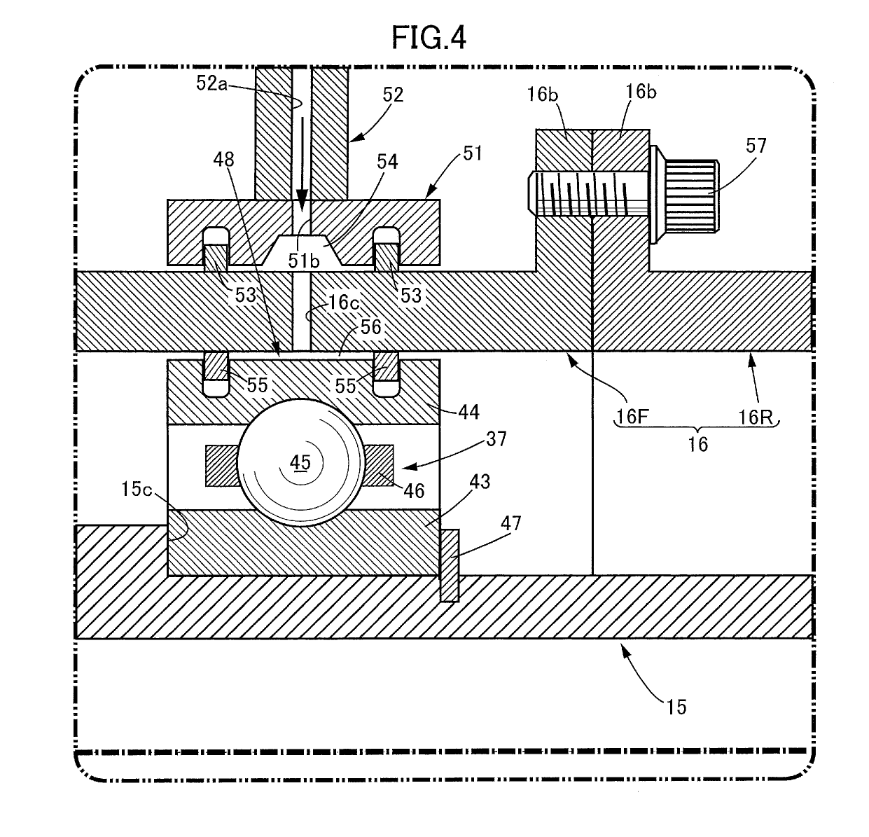

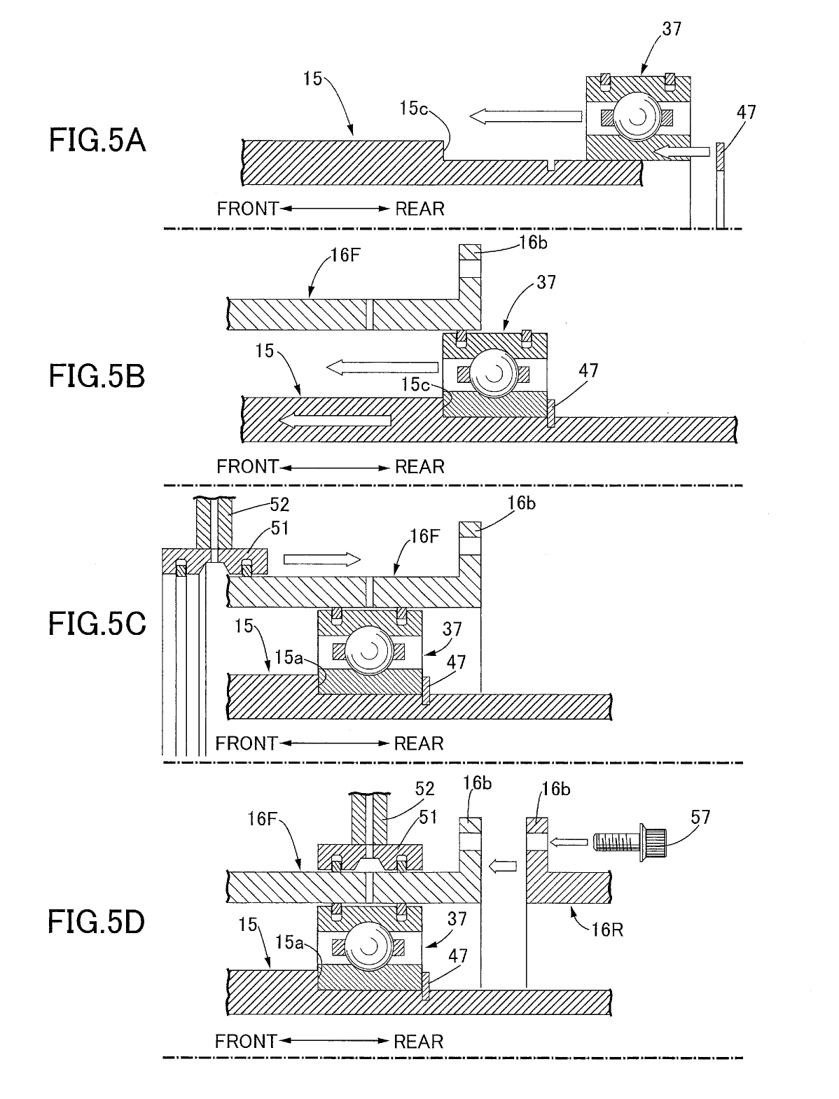

A second embodiment of the present invention is now explained by reference to FIGS. 4 to 5D. In the first embodiment described above, oil is supplied from the interior of the low pressure system shaft 15 to the squeeze film damper 48, but in the second embodiment oil is supplied to the squeeze film damper 48 from the outside of the high pressure system shaft 16.

As shown in FIG. 4, in the second embodiment, since it is unnecessary to dispose the stationary member 51 in the interior of the low pressure system shaft 15, the low pressure system shaft 15 is not divided into two but is formed from one member. On the other hand, the high pressure system shaft 16 is divided into two, that is, a front high pressure system shaft 16F and a rear high pressure system shaft 16R, which are joined as a unit by means of a plurality of bolts 57 extending through joining flanges 16b. The intermediate bearing 37 has its inner race 43 sandwiched between a step portion 15c of the low pressure system shaft 15 and a clip 47 and latched so that it cannot move in the axial direction.

The squeeze film damper 48 includes an annular stationary member 51 disposed on the radially outer side of the front high pressure system shaft 16F, and fixing, to a stationary part such as the inner casing 12 or the like, a linking member 52 extending from the stationary member 51 to the radially outer side fixes the stationary member 51 to the exterior of the front high pressure system shaft 16F so that it cannot move. Abutting a pair of seal rings 53 provided on the inner periphery of the stationary member 51 against the outer periphery of the front high pressure system shaft 16F defines an annular oil chamber 54 between the inner periphery of the stationary member 51 and the outer periphery of the front high pressure system shaft 16F. Oil is supplied from an oil pump, which is not illustrated, to the oil chamber 54 through an oil passage 52a formed in the interior of the linking member 52 and the oil hole 51b extending through the stationary member 51 in the radial direction.

Furthermore, the squeeze film damper 48 includes an annular oil chamber 56 sandwiched between the outer periphery of the outer race 46 of the intermediate bearing 37 and the inner periphery of the front high pressure system shaft 16F and defined by a pair of seal rings 55 provided on the outer periphery of the outer race 46 of the intermediate bearing 37. Oil of the oil chamber 54 is supplied to the oil chamber 56 via an oil hole 16c extending through the front high pressure system shaft 16F in the radial direction.

In order to assemble the intermediate bearing 37 between the low pressure system shaft 15 and the high pressure system shaft 16, first the intermediate bearing 37 is inserted from the rear to the front around the outer periphery of the low pressure system shaft 15, and the inner race 43 is abutted against the step portion 15c of the low pressure system shaft 15 and latched by means of the clip 47, thereby supporting the intermediate bearing 37 on the low pressure system shaft 15 (see FIG. 5A).

Subsequently, the low pressure system shaft 15 integrally having the intermediate bearing 37 is inserted from the rear to the front so as to be fitted into the inner periphery of the front high pressure system shaft 16F (see FIG. 5B). Subsequently, the stationary member 51 and the linking member 52, which are joined as a unit in advance, are inserted from the front to the rear around the outer periphery of the front high pressure system shaft 16F, and the outer end in the radial direction of the linking member 52 is fixed to an appropriate fixing part of the inner casing 12 (see FIG. 5C). Lastly, the front end of the rear high pressure system shaft 16R is joined to the rear end of the front high pressure system shaft 16F by means of the bolts 57 (see FIG. 5D).

In this way, it becomes possible to assemble the intermediate bearing 37 in a confined space between the low pressure system shaft 15 and the high pressure system shaft 16 without any problem.

Also in accordance with the second embodiment described above, disposing the intermediate bearing 37 between the outer periphery of the low pressure system shaft 15 and the inner periphery of the high pressure system shaft 16 not only enhances the bending stiffness of the low pressure system shaft 15 and the high pressure system shaft 16 to thus suppress the occurrence of vibration due to centrifugal whirling, but also damps, by means of the squeeze film damper 48, vibration due to centrifugal whirling occurring on the low pressure system shaft 15 and the high pressure system shaft 16 that has not been sufficiently suppressed, thereby reliably preventing any damage to the inner casing 12 caused by the transmission of vibration.

Embodiments of the present invention are explained above, but the present invention may be modified in a variety of ways as long as the modifications do not depart from the gist of the present invention.

For example, the third bearing of the present invention is not limited to the ball bearing of the embodiments and may be another type of bearing such as a roller bearing or a needle bearing.

Furthermore, in the embodiments the intermediate bearing 37 is supported on the inner periphery of the front high pressure system shaft 16F, but it may be supported on the inner periphery of the rear high pressure system shaft 16R.

What is claimed is:

1. A gas turbine engine comprising a low pressure system shaft that supports a low pressure compressor and a low pressure turbine, a high pressure system shaft that is fitted around an outer periphery of an intermediate part in an axial direction of the low pressure system shaft and supports a high pressure compressor and a high pressure turbine, a front first bearing and a rear first bearing that support opposite ends in the axial direction of the low pressure system shaft on a casing, and a front second bearing and a rear second bearing that support opposite ends in an axial direction of the high pressure system shaft on the casing,
wherein a third bearing having a squeeze film damper is disposed between the outer periphery of the intermediate part in the axial direction of the low pressure system shaft and an inner periphery of an intermediate part in the axial direction the high pressure system shaft.

2. The gas turbine engine according to claim 1, wherein the high pressure system shaft is formed from a front high pressure system shaft and a rear high pressure system shaft divided between the front second bearing and the rear second bearing, the third bearing is supported on an inner periphery of one of the front high pressure system shaft and the rear high pressure system shaft, and the front high pressure system shaft and the rear high pressure system shaft are joined by a coupling.
